(19) United States
(12) Patent Application Publication
(10) Pub. No.: US 2014/0101048 A1
(43) Pub. Date: Apr. 10, 2014

(54) System and Method for Enrollment of Payment Transaction Services

(71) Applicant: BARCLAYS BANK PLC, London (GB)

(72) Inventors: James Gardiner, Buckinghamshire (GB); Colin McSkeane, Bedfordshire (GB)

(73) Assignee: BARCLAYS BANK PLC, London (GB)

(21) Appl. No.: 13/668,850

(22) Filed: Nov. 5, 2012

(30) Foreign Application Priority Data
Oct. 10, 2012 (GB) 1218188.9

(51) Int. Cl. G06Q 20/30

(52) U.S. Cl. CPC G06Q 20/30
USPC 705/44

(57) ABSTRACT

In an electronic payment transaction, a mobile device captures customer payment token data using an integrated camera. A user is registered to initiate the payment transaction using a mobile payment application on the mobile device. The registration process involves retrieving customer data associated with the captured customer payment token data to pre-populate an enrollment form. The user authentication is provided by verifying input authentication data or by an existing mobile service application.

### FIELD OF THE INVENTION

This invention relates to a transaction payment system, and more particularly to a system and method for providing enhanced enrollment for card payment transaction services.

### BACKGROUND OF THE INVENTION

Payment transaction systems that use a mobile data terminal to handle ‘Point of Sale’ (POS) credit/debit card transactions for a merchant are known. Typically, the merchant's data terminal can be a mobile smartphone, tablet computer or portable computing device with cellular data communication capabilities, such as General Packet Radio Service (GPRS), Enhanced Data rates for GSM Evolution (EDGE) or 3G (3^{rd} generation mobile telecommunications technology), and capable of running a payment application. The payment application preferably provides accounting functions for the merchant, such as calculating a total bill, printing receipts, providing summaries of transactions etc. The payment application also communicates electronically with a transaction processing back-end server to process and settle the transactions.

A payment card reader may be provided as a peripheral device in communication with the data terminal. Alternatively, the merchant's data terminal may capture the customer's card details using a scanner or camera, for example as disclosed in US-A-2010/0008535 (Jumio). This technique does not require a card reader, so may be implemented on a standard smartphone with an integrated camera, but is inherently less secure than the commonly used ‘Chip and PIN’ card reader where a computer chip is embedded in a smartcard and a personal identification number (PIN) is provided by the consumer for completion of a transaction.

As such card payment systems become more prevalent, there is a need for improved systems and techniques to provide more efficient tools and processes for enrollment of available services, without sacrificing security against fraudulent use.

### STATEMENTS OF THE INVENTION

Aspects of the present invention are set out in the accompanying claims.

According to one aspect of the present invention, there is provided a method and system for authenticating a payment transaction between a merchant and a customer in an electronic payment system, in which a mobile device captures payment token data for the transaction without the need for a dedicated card reader. Preferably, a camera integrated with the mobile device is used to capture an image of the card, from which payment token data are extracted by known Optical Character Recognition (OCR) techniques.

A user, for example, a merchant, is registered to initiate the payment transaction using a mobile payment application on the mobile device. The registration process involves retrieving data associated with the payment token of the user to pre-populate an enrollment form. Preferably, user authentication is also provided by verifying input authentication data.

According to another aspect, there is provided a method and system for processing enrollment of a user for a mobile payment transaction service in an electronic banking system, the user being pre-registered for another service in the electronic banking system. A mobile device captures payment token data for the enrollment process and the transaction process without the need for a dedicated card reader, and user authentication is provided by an existing mobile service application on the mobile device.

In a further aspect of the present invention there is provided a mobile device, an authentication system, and associated computer programs arranged to carry out at least one of the above methods.

### BRIEF DESCRIPTION OF THE DRAWINGS

There now follows, by way of example only, a detailed description of embodiments of the present invention, with references to the figures identified below.

FIG. 1 is a block diagram showing the main components of a payment processing system according to an embodiment of the invention.

FIG. 2, which comprises FIGS. 2A and 2B, is a flow diagram illustrating the main processing steps performed by the system of FIG. 1.

FIG. 3 is a flow diagram illustrating the sub processing steps performed by the system of FIG. 1 to process a payment transaction according to an exemplary embodiment.

FIG. 4 is a block diagram showing the main components of a payment processing system according to an alternative embodiment of the invention.

FIG. 5 is a diagram of an exemplary computer system on which one or more of the functions of the embodiment may be implemented.

### DETAILED DESCRIPTION OF EMBODIMENTS OF THE INVENTION

### Card Payment Background

Card payments are a way of paying for goods and services without cash changing hands. It is appreciated various names may be applied in designating the parties of a transaction, and those using the present system. In accordance with the present description, the term “merchant” is used to describe the receiver of payment, for example, for goods or services, and “customer” is used to describe the provider of payment. The presentation of the payment token data and appropriate cardholder authentication guarantee the merchant payment. A conventional card payment system is made up of a number of components: cardholder, merchant, acquirer, scheme and card issuer. As is appreciated by those skilled in the art, the cardholder is the consumer purchasing goods or services with a card, the merchant is selling the goods or services to the consumer, the acquirer is an intermediary that functions to process the transaction on behalf of the merchant and card issuer, the scheme refers to the entity operating a specific transaction protocol (i.e., rules for the interchange) in which the cardholder, merchant, merchant acquirer and card issuer have agreed to participate, and the card issuer is the bank or other entity offering the cards directly to the consumer and ultimately assuming financial liability for the transaction by providing the cardholder with a line of credit.

In the normal process the cardholder presents his card (or payment token) to the merchant in order to pay for goods or services rendered; this transaction may take place over any one of a number of channels (in store or via the Internet, for example). The merchant, through his acquirer, is set up to accept different card types by scheme (Visa®, MasterCard®, Amex®, credit, debit, for example). When a card is presented, the cardholder is authenticated (by Personal Identification Number, PIN, passcode, or Card Verification Value, CV2, for example), subject to channel and merchant capability, and the transaction is submitted to the merchant's acquirer (referred to herein as “merchant acquirer”) for authorisation. Authorisation and authentication of the merchant and/or cardholder may instead or additionally be handled through a trusted third party authentication system that is known to the merchant acquirer.

Once the transaction is received, the merchant acquirer routes the authorisation transaction, in real time, to the relevant scheme based upon card type. The scheme provides isolation between merchant acquirers and card issuers for routing of authorisations, settlements and funds movement. The merchant acquirer doesn't need to know who the card issuer is, just which scheme to route it to which is determined by Bank Identification Number (BIN).

The card issuer authorises the transaction based upon the cardholder's balance and other risk/fraud criteria and returns an authorised message and authorisation code to the scheme, which routes it back to the merchant acquirer who sent it to the merchant. The merchant then confirms the sale, which posts a settlement transaction to the merchant acquirer; this is a mandate to make the payment and move funds. The settlement transaction is routed between merchant acquirers and card issuers via the scheme.

### Technical Architecture

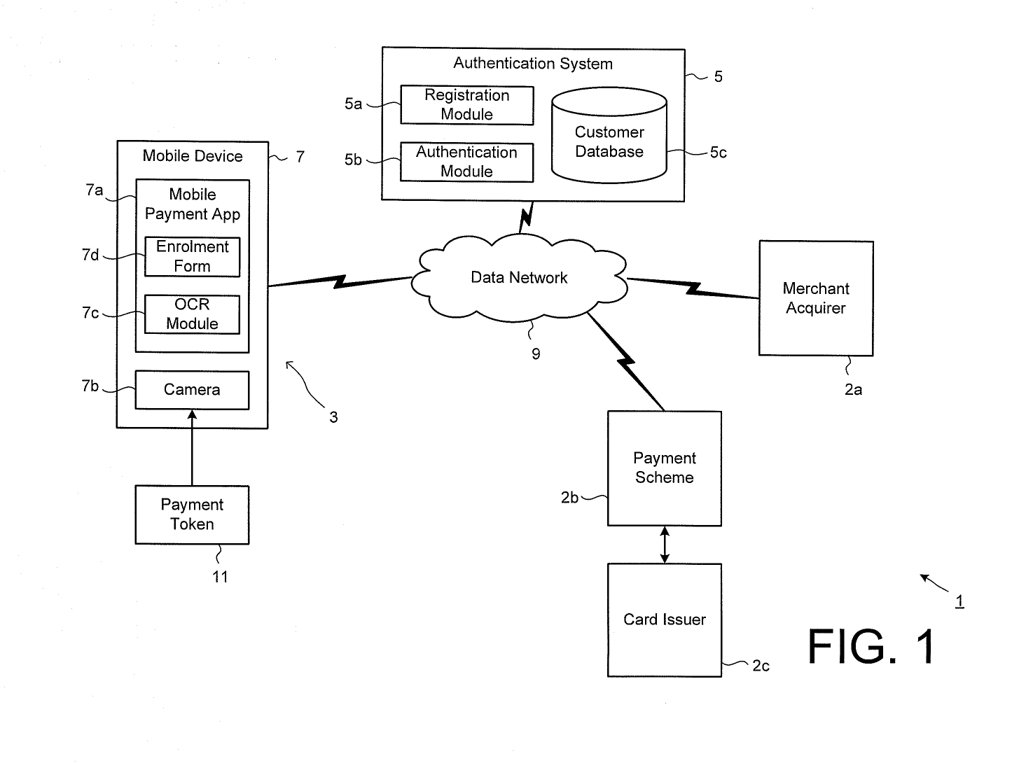

Referring to FIG. 1, a payment transaction system 1 according to an embodiment of the invention is disclosed. The present payment transaction system 1 provides a computer-implemented method of processing enrollment of a user for a payment transaction service in an electronic banking system, the user being registered for another service in the electronic banking system. The method is achieved by initiating an enrollment request for the mobile payment transaction service from an existing mobile payment application at a user mobile device and capturing payment token data from a digital image of a payment token presented by the user. User data associated with the payment token data is retrieved to populate at least a portion of an enrollment form for registering the user to initiate the payment transaction using a mobile payment application on the user mobile device. Authentication of the user is provided by the existing mobile payment application.

With this foregoing methodology in mind, the present payment transaction system 1 comprises a merchant system 3 for initiating payment transactions, such as credit/debit card transactions, through a mobile payment application 7a running on a mobile device 7. In a typical payment transaction process, the mobile payment application 7a receives data identifying goods and/or services associated with the payment transaction, applies discounts or vouchers, determines the total amount due for payment, and initiates authentication of a payment token 11 presented by the customer (that is, the cardholder or token holder). The mobile payment application 7a must obtain details of the payment token 11 before the payment transaction can be settled and completed.

In the present embodiment, the payment token 11 is a credit or debit card of conventional type, carrying at least a card number, expiration date and cardholder name on the front side and a card security code on the reverse side. Optionally, the card may include additional information identifying an associated bank account, such as an account number and branch sort code.

The mobile device 7 can be a mobile smartphone, tablet computer or portable computing device, or the like, and communicates with a transaction processing module, in particular, an authentication system 5 via a data network 9. The mobile payment application 7a is preferably secured by means of a passcode and information associated with a payment transaction can be provided via the secured mobile payment application 7a running on the mobile device 7. Electronic data communication by the mobile payment application 7a may be encrypted to enhance the overall security of the present system.

The merchant system 3 is connected to an authentication system 5, a merchant acquirer 2a, the payment scheme 2b and the card issuer 2c via a data network 9. The data network 9 may be any suitable data communication network such as a wireless network, a local- or wide-area network including a corporate intranet or the Internet, using for example the TCP/IP protocol, or a cellular communication network such as GPRS, EDGE or 3G, for example. Such communication protocols are of a type that are known per se in data networks and need not be described further.

As is appreciated, components of the merchant system 3 are in communication with a merchant acquirer 2a, payment scheme 2b and card issuer 2c components over the data network 9, which are typically provided for authorizing and settling card payment transactions as described in the section above, and need not be described further.

In this embodiment of the present invention, additional authentication is handled through the authentication system 5 hosted by a trusted third party that is known to the merchant acquirer 2a. Alternatively, the authentication system 5 may be provided as a component of the merchant acquirer 2a. As will be described below, this authentication system 5 includes a registration module 5a for processing registration of the merchant to initiate payment transactions using the mobile payment application 7a on the mobile device 7, and an authentication module 5b for providing an authentication security check, for example prior to registration processing and/or authorisation processing of a payment transaction. Additionally, the authentication system 5 can store information associated with registered cardholders of the system 1, in a database 5c. Alternatively, the authentication system 5 can be adapted to retrieve the information from the card issuer 2c.

As part of the requirement that the merchant system 3 collect payment token data in conjunction with the processing of a card transaction, the mobile device 7 includes a digital camera 7b for scanning or imaging the payment token 11 so as to capture the payment token data (that is, card details (for example, card number, cardholder name, expiration date, etc.) at least from the front side of the card. The digital camera 7b is controlled by the mobile payment application 7a to capture a digital still or moving image of the front side of the card. The mobile payment application 7a obtains the card details from the digital image using an Optical Character Recognition (OCR) module 7c.

The mobile device 7 also includes a graphical user interface 7e upon which an electronic enrollment form 7d used in the registration of merchants using the present payment transaction system 1 is displayed. The electronic enrollment form 7d provides a mechanism for receiving information from the merchant during the registration process. As will be described below, the registration module 5a retrieves data associated with the payment token 11a of the merchant from the database 5c, and the retrieved data is used by the mobile payment application 7a to pre-populate respective input data fields in the enrollment form 7d. By pre-populating the enrollment form 7d in this way, the registration process is more efficient and security of the payment system is not compromised.

### Mobile Payment Application Registration Process

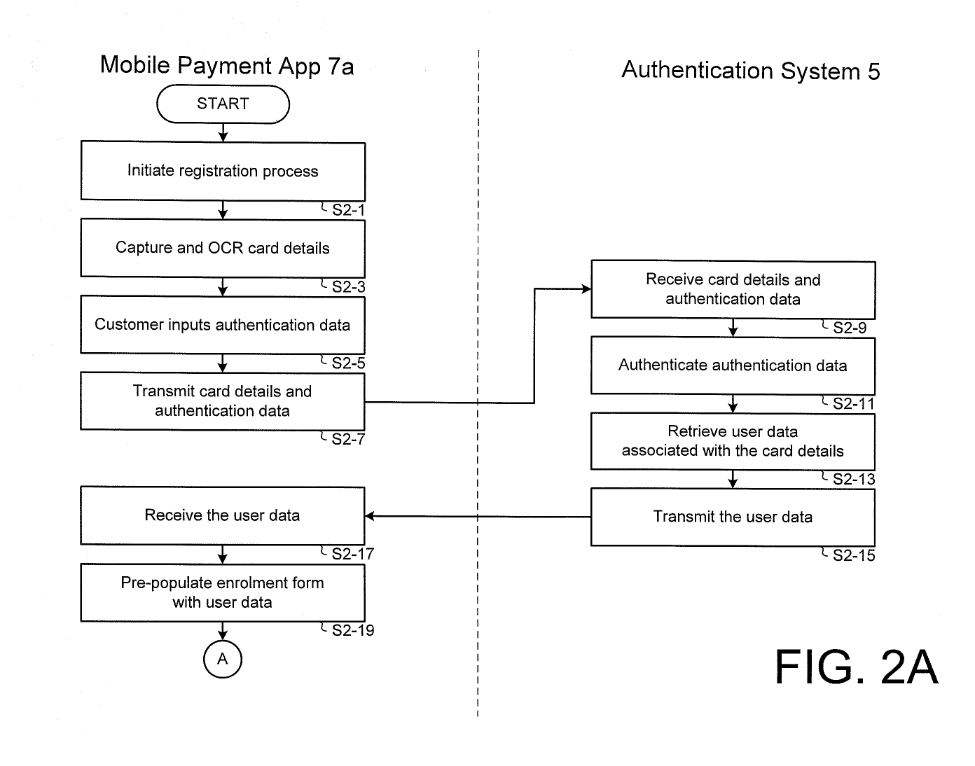

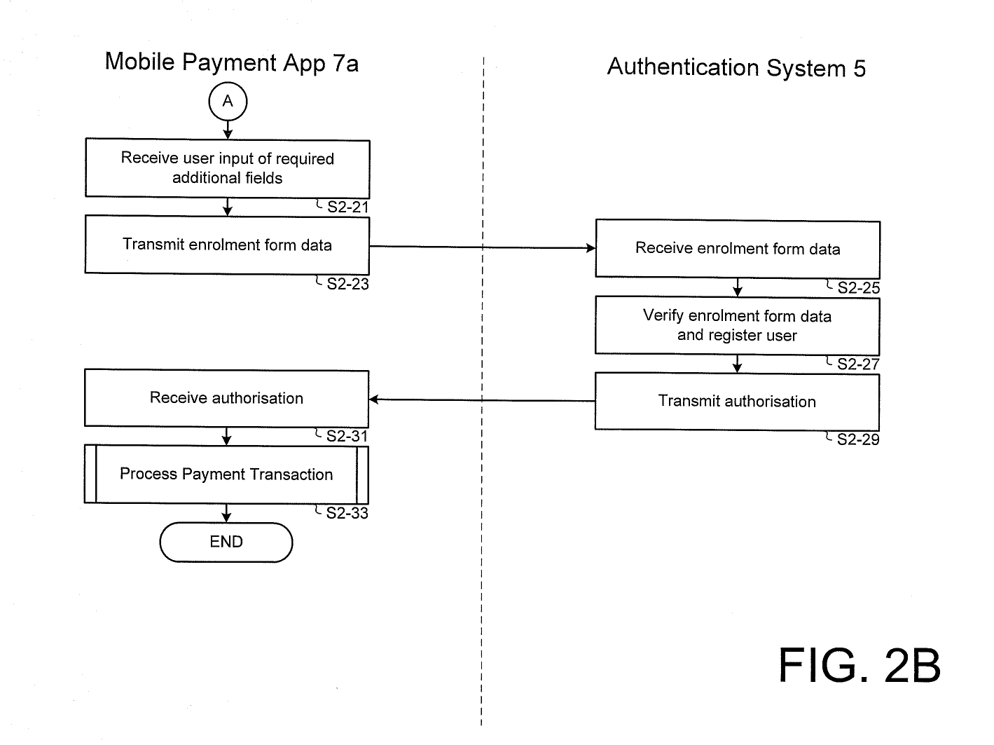

An embodiment of a process of registering a user for the mobile payment application 7a will now be described with reference to FIG. 2, to illustrate the technical advantage of the payment transaction system 1 embodiment described above. In this embodiment, the user is a merchant, although, and as discussed above, the user may take a variety of forms depending upon the needs of the user.

The registration process begins at step S2-1 where the mobile payment application 7a on the mobile device 7 receives merchant input to initiate a registration process. The registration process can be initiated the first time that the merchant launches the mobile payment application 7a, for example after installation of the application on the mobile device 7.

At step S2-3, the mobile payment application 7a captures a digital image of the front side of a payment taken 11a, for example, card, presented by the merchant and obtains the payment token data using an OCR process on the digital image, as described above. This conveniently avoids the merchant having to enter the card number and other details manually.

At step S2-5, the mobile payment application 7a prompts the merchant to input authentication data. In accordance with a preferred embodiment, the graphical user interface 7e is a touchscreen which may be used for the input of authentication data as well as for the enrollment form 7d as discussed below. It will be appreciated that merchant authentication can take one or more of any number of known forms. As one example, the merchant can input a unique, one-time passcode generated by an external card reader and authentication device (not illustrated). As another example, the mobile device 7 can include a one-time passcode generator module (not illustrated) to generate and pass a unique one-time passcode to the mobile payment application 7a, or the mobile payment application 7a itself can include such a one-time passcode generator module. As yet another example, the mobile payment application 7a displays a data entry screen to the merchant, prompting the merchant to enter their card security code, such as the CV2 code. The mobile payment application 7a may request input of alternative or additional authentication information, such as the cardholder's postal (zip) code, details of a recent transaction, passwords or passcodes from other related servicing accounts, answer to a pre-registered security questions such as the cardholder's favourite colour or make of first car, etc.

At step S2-7, the mobile payment application 7a transmits the input authentication data together with the captured payment token data, to the authentication system 5 where the authentication data and the payment token data are received, at step S2-9. At step S2-11, the authentication module 5b in the authentication system 5 uses the payment token data to access a corresponding cardholder record in the database 5c and authenticates the authentication data against the cardholder record, to verify that the merchant is the owner of the captured payment token data. After the merchant is authenticated, the authentication system 5 retrieves merchant data from the cardholder record, at step S2-13. The merchant data can include one or more of the cardholder's name, address, contact details, bank account number, business or trading name, trading address, etc. that would have been captured by a previous registration and authentication process, for example when the merchant applied for the payment token. The merchant data may be encoded using a standard format, such as XML, that identifies a respective element type associated with each value in the merchant data.

At step S2-15, the authentication system 5 transmits the retrieved merchant data to the mobile payment application 7a where the data is received, at step S2-17. At step S2-19, the mobile payment application 7a uses the merchant data to pre-populate as many input data fields as possible in the enrollment form 7d as displayed in the graphical user interface 7e. For example, the mobile payment application 7a may match element types in the received merchant data to input data field types in the enrollment form 7d to determine the fields that can be populated with associated values in the received merchant data.

After the mobile payment application 7a pre-populates the enrollment form 7d with the received merchant data, the merchant may be prompted to review all pre-populated data. At step S2-21, the mobile payment application 7a receives merchant input to edit or complete any additional required fields where the associated values were not available from the user data. For example, in the case of a merchant account, the additional required details may include business turnover, expected card turnover, average transaction value, whether the merchant takes payment for a deferred delivery or takes deposits, etc. The system may be configured to assign default values for some or all of these fields, such as expected card turnover and average transaction value, and the merchant may be able to edit the pre-populated default values.

At step S2-23, the mobile payment application 7a transmits the completed enrollment form 7d to the registration module 5a of the authentication system 5 where the data from the enrollment form 7d is received, at step S2-25. At step S2-27, the authentication system 5 verifies the input data of the enrollment form 7d against the corresponding cardholder record in the database 5c before registering the merchant as an authorised user to initiate payment transactions using the mobile payment application 7a on the mobile device 7. It will be appreciated that the registration decisioning process may involve additional processing steps before registration is approved or declined, such as carrying out a series of additional checks, including credit bureau checks and payment scheme checks (e.g. Visa/Mastercard) as are known per se. At step S2-29, the authentication system 5 transmits data indicative of authorisation to the mobile payment application 7a where the data is received, at step S2-31. The mobile payment application 7a is thereby enabled for the approved and registered merchant to initiate and process a payment transaction, at step S2-33. In this way, the mobile device 7 is effectively initiated after receiving the approved decision, such that all mobile payment functionality via the mobile payment application 7a becomes unlocked and the merchant is able to process card payments and use all additional features provided by the mobile payment application 7a.

Optionally, if the authentication system 5 fails to authenticate the authentication data and/or verify the enrollment form data, or if the decisioning process otherwise fails and the merchant is not approved for registration, the authentication system 5 may send an alert message to an address registered in the cardholder record to inform the merchant of the decision. The address may be a mobile number for sending a text or multimedia message, an email address, or a postal address.

### Payment Authentication Process

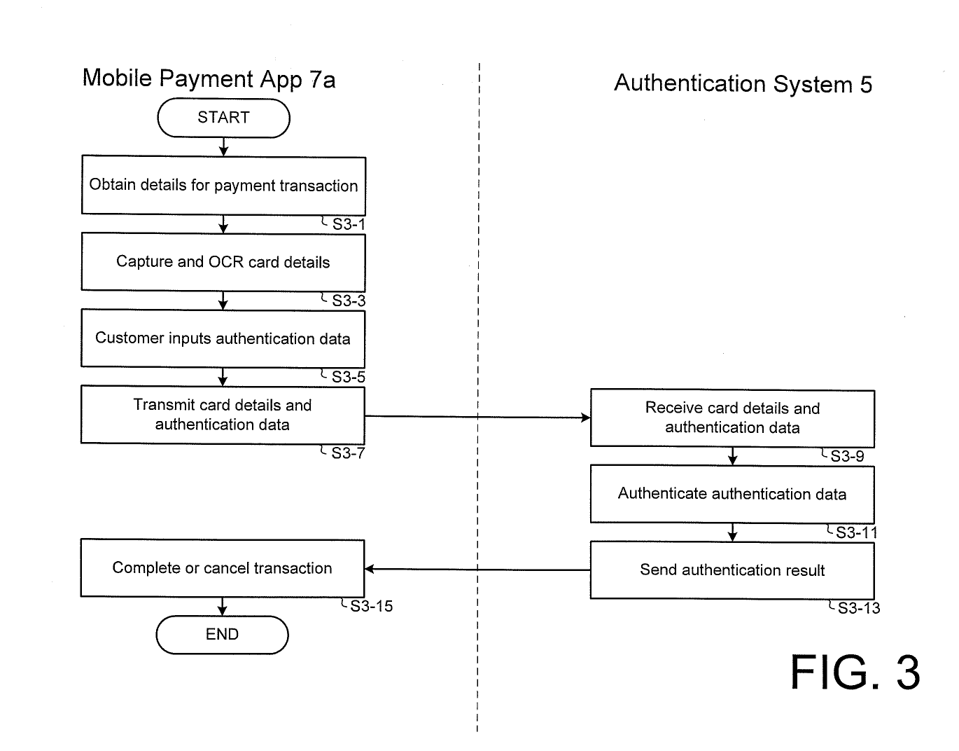

An exemplary embodiment of the process of payment authentication at step S2-33 will now be described in further detail with reference to FIG. 3, to illustrate the technical synergy between the registration process and the payment authentication process that both involve the captured payment token data.

The payment authentication process begins at step S3-1 where details for a new payment transaction are obtained by the mobile payment application 7a running on the mobile device 7 of the merchant. The transaction details typically include a payment amount to be transferred and data identifying the transaction, such as the time and date of the transaction and a description of the associated goods or services. The mobile payment application 7a may scan codes (such as 1D barcodes or 2D QR codes) associated with the goods or services to obtain details of the transaction.

At step S3-3, the mobile payment application 7a captures a digital image of the front side of a card 11 presented by the customer and obtains the payment token data using an OCR process on the digital image, as described above. Again, this avoids the merchant or customer from having to enter the card number and other details manually, whilst maintaining a degree of security as the card must be present for this step of the payment transaction process.

At step S3-5, the mobile payment application 7a displays a data entry screen prompting the merchant or customer to enter the card security code, such as the CV2 code, of the customer. The mobile payment application 7a may request input of alternative or additional authentication information, such as the cardholder's postal (zip) code for comparison with the cardholder's registered billing address.

At step S3-7, the mobile payment application 7a transmits the received authentication data together with the captured payment token data, to the authentication system 5 where the authentication data and payment token data are received by the authentication module 5b, at step S3-9. At step S3-11, the authentication system 5 uses the payment token data to access a corresponding cardholder record from the database 5c and authenticates the authentication data against the cardholder record. It will be appreciate that the cardholder record may be typically held by the card issuer 2c, so the authentication system 5 may delegate the authentication step to the card issuer 2c, via the payment scheme 2b, and receive an authentication response from the card issuer 2c. Alternatively, the mobile payment application 7a may send the authentication data to the merchant acquirer 2a for authentication.

At step S3-13, the authentication system 5 sends an authentication result to the mobile payment application 7a, dependent on the authentication of the authentication data. At step S3-15, the mobile payment application 7a may complete or cancel the transaction, depending on the received authentication result.

Optionally, if the authentication system 5 fails to authenticate the authentication data during the payment authentication process, it may send an alert message to an address registered in the cardholder record, as described above.

In this way, acquirers and merchants in the payment transaction system are provided with a more efficient registration and payment transaction processing system whilst maintaining security and non-repudiation of payment transactions.

### Alternative Embodiment

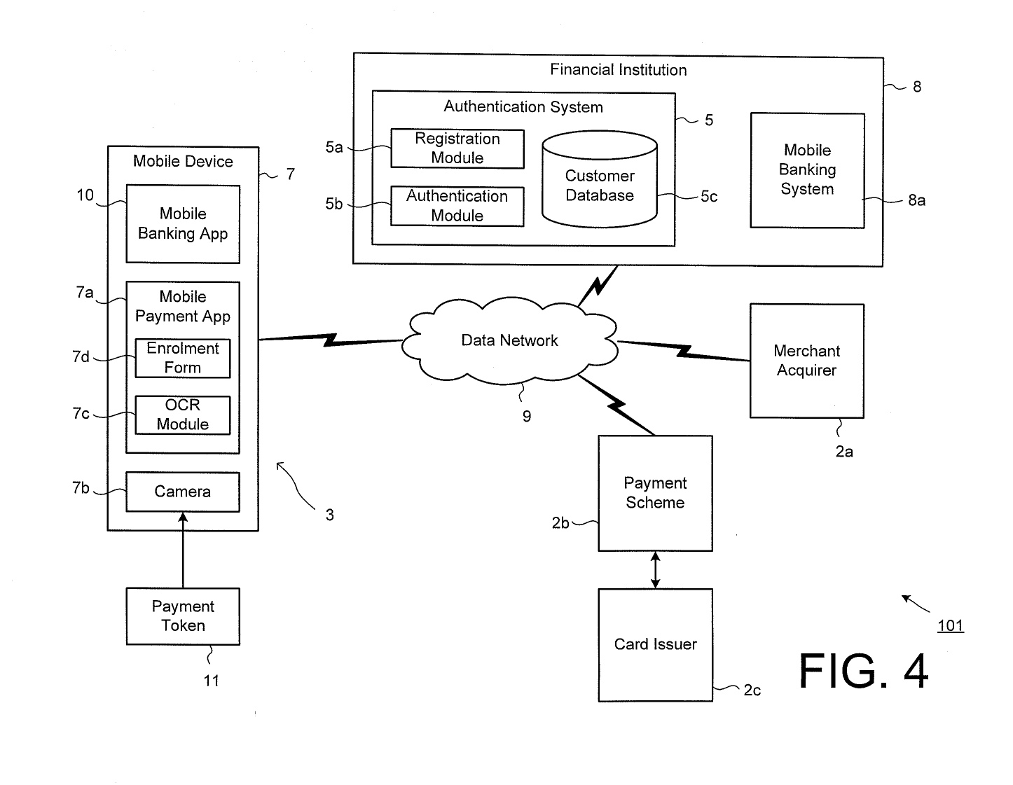

A further embodiment will now be described using corresponding reference numerals to those of preceding figures where appropriate for corresponding elements. Referring to FIG. 4, a payment transaction system 101 according to an alternative embodiment of the invention comprises a merchant system 3 for initiating payment transactions, such as credit/debit card transactions, through a mobile payment application 7a running on a mobile device 7. In this embodiment, additional authentication is handled through an authentication system 5 hosted by a trusted financial institution 8 that is known to the merchant acquirer 2a.

In this embodiment, the mobile device 7 includes an additional mobile banking application 10 that the merchant has previously installed and registered, prior to the registration process for the mobile payment application 7a. The existing mobile banking application 10 provides mobile services to the merchant, who has already registered with the associated mobile banking system 8a of the financial institution 8 after authentication by the authentication system 5. The mobile services provided by the mobile banking application 10 can be any form of existing service, such as transferring of funds between registered mobile device users, accessing banking account details, mobile banking, credit card account servicing, etc.

In this embodiment, the registration process is initiated by receiving a merchant request from within the existing mobile banking application 10 in order to register for the mobile payment application 7a. The existing mobile banking application 10 requires secure log in by the merchant before the merchant can initiate the request, for example by means of a passcode. Therefore, the merchant is already authenticated with the financial institution at the time of submitting the request, and the authentication steps S2-5 and S2-11 described above are not performed by the payment transaction system 101 in this alternative embodiment. Instead, the payment token data are captured and processed by the OCR module 7c at step S2-3, transmitted to the registration module 5a at step S2-7, received at step S2-9, and processed by the authentication system 5 as described from step S2-13 of the embodiment above.

As a further modification, the embodiments described above can be combined whereby the registration process is initiated from the mobile payment application 7a but authentication of the merchant is verified by merchant confirming secure log in to the existing mobile banking application 10. In this modified embodiment, the merchant can be prompted to input unique identification data, such as a mobile phone number and the mobile payment application 7a can create a link to the mobile banking application 10.

In these ways, additional efficiencies are gained by the registration and payment transaction processing system.

### FURTHER ALTERNATIVE EMBODIMENTS

It will be understood that embodiments of the present invention are described herein by way of example only, and that various changes and modifications may be made without departing from the scope of the invention.

The passcodes described above may take any respective form, and may be composed of numeric or alphabetic symbols, non-alphanumeric symbols, or a combination of such symbols.

The division of operations between the mobile payment application 7a and the authentication system 5 may differ from that described in the embodiment above. For example, the digital image of the card may be sent to the authentication system 5 for OCR processing. In this case, less processing is required by the mobile payment application 7a, at the expense of greater bandwidth requirements between the mobile payment application 7a and the authentication system 5.

Alternative embodiments may be envisaged, which nevertheless fall within the scope of the following claims.

### Computer Systems

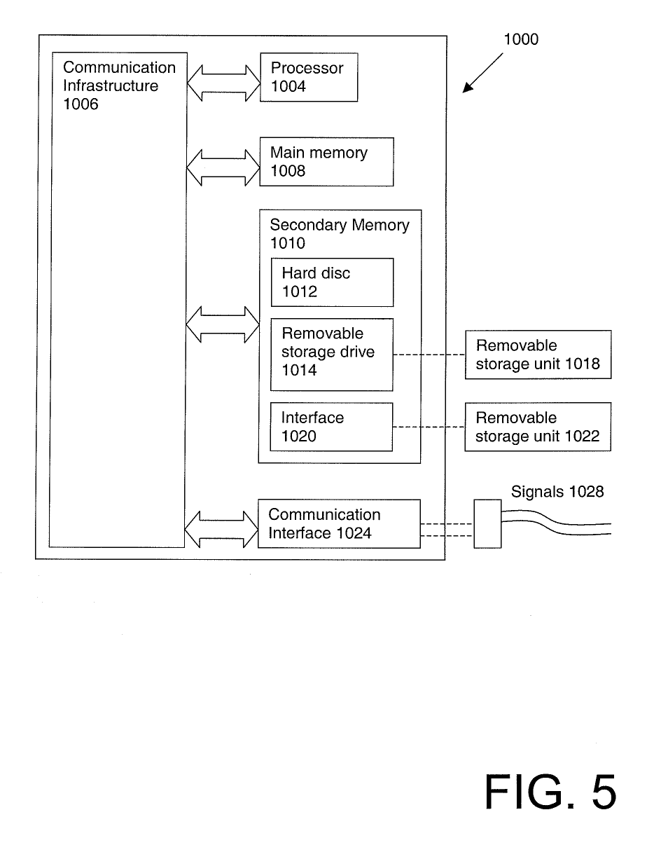

The entities described herein, such as the mobile device 7 or authentication system 5, are preferably implemented by computer systems such as computer system 1000 as shown in FIG. 5. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 618 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an erasable programmable read only memory (EPROM), or programmable read only memory (PROM), or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product and loaded into computer system 1000 using removable storage drive 1014, hard disk drive 1012, or communication interface 1024, to provide some examples.

Alternative embodiments may be implemented as control logic in hardware, firmware, or software or any combination thereof.

1. A computer-implemented method of processing enrollment of a user for a payment transaction service in an electronic banking system, the user being registered for another service in the electronic banking system, the method comprising the steps of:
a. initiating an enrollment request for the mobile payment transaction service from an existing mobile payment application at a user mobile device;
b. capturing payment token data from a digital image of a payment token presented by the user; and
c. retrieving user data associated with the payment token data to populate at least a portion of an enrollment form for registering the user to initiate the payment transaction using a mobile payment application on the user mobile device;
wherein authentication of the user is provided by the existing mobile payment application.

2. The method of claim 1, wherein the user securely logs in to the existing mobile payment application.

3. The method of claim 1, wherein the digital image is obtained using a camera integrated with the user device.

4. The method of claim 1, wherein the payment token comprises a bank card.

5. The method of claim 1, wherein the payment token data comprises an account number displayed on the payment token.

6. The method of claim 1, wherein the enrollment form comprises a plurality of input data fields each associated with a respective element type, and wherein data fields of the enrollment form are populated with user data values of a matching element type.

7. The method of claim 6, further comprising receiving user input for additional required input data fields that are not populated with user data values.

8. The method of claim 1, including the further step of authenticating a payment transaction of a customer.

9. The method of claim 8, wherein the step of authenticating a payment transaction includes capturing payment token data from a digital image of a payment token presented by the customer and transmitting the payment token data to an authentication system for authentication of the payment transaction.

10. A system for processing enrollment of a user for a payment transaction service in an electronic banking system, the user being registered for another service in the electronic banking system, the system comprising:
a user mobile device, the user mobile device including mobile payment application, the mobile payment application including means for initiating an enrollment request for a payment transaction service from the mobile payment application at a merchant device, the user mobile device including a camera for capturing payment token data as a digital image of a payment token presented by the user and also including a graphical user interface for inputting authentication data; and
an authentication system in communication with the user mobile device for receipt of the payment token data and the authentication data, the authentication system including a registration module for retrieving user data associated with the payment token data from a database, the user data being sent to the user mobile device for populating at least a portion of an enrollment form of the payment application on the user mobile device, the authentication system also including an authentication module receiving the authentication data and authenticating the user;
the mobile payment application of the user mobile device includes a graphical user interface allowing the user to confirm the enrollment form for registering the user to initiate the payment transaction using a mobile payment application on the mobile device and transmitting the enrollment form to the authentication system which verifies and registers the user for transaction services.

11. The system of claim 10, wherein the payment token comprises a bank card.

12. The system of claim 10, wherein the payment token data comprises an account number displayed on the payment token.

13. The system of claim 10, wherein the enrollment form comprises a plurality of input data fields each associated with a respective element type, and wherein data fields of the enrollment form are populated with user data values of a matching element type.

14. The system of claim 13, wherein the graphical user interface provides for user input of additional required input data fields that are not populated with user data values.
